(19) United States
(12) Patent Application Publication
(10) Pub. No.: US 2002/0188458 A1
(43) Pub. Date: Dec. 12, 2002

(54) Methods and apparatus for a distributed enterprise portal architecture

(76) Inventor: Bobby Babbrah, Tempe, AZ (US)

Correspondence Address: SNELL & WILMER, ONE ARIZONA CENTER, 400 EAST VAN BUREN, PHOENIX, AZ, 850040001

(21) Appl. No.: 09/955,743

(22) Filed: Sep. 17, 2001

Related U.S. Application Data
(60) Provisional application No. 60/233,073, filed on Sep. 15, 2000.

(51) Int. Cl. G06F 17/60

(52) U.S. Cl. 705/1

(57) ABSTRACT

A distributed architecture for an enterprise portal involves a network of connected, department-sized portal servers working together as a group of federated portals, including a union of independent entities working together to provide specific functions. An enterprise portal architecture includes a number of user systems connected, over a network, to at least two portals, a plurality of data sources coupled over a network to the portals, where each of the portals include a knowledge framework unit. The knowledge framework units, which are interconnected, each include a digital business identity and a knowledge broker, wherein the digital business identity includes a user directory configured to store information unique to a subset of said plurality of users, and wherein the knowledge broker includes a meta-data directory.

### CROSS-REFERENCE TO RELATED APPLICATIONS

This application claims priority U.S. Provisional Application Serial No. 60/233,073, filed Sep. 15, 2000, the contents of which is hereby incorporated by reference.

### BACKGROUND OF THE INVENTION

1. Technical Field

The present invention relates, generally, to data communication over a network and, more particularly, to enterprise portal systems providing access to corporate data sources.

2. Background Information

Ideally, an enterprise portal includes a browser-based system that allows knowledge A workers in an enterprise to access the information they need to do their job, regardless of where that data is stored. By providing access to numerous corporate data sources through a single web interface, called an enterprise portal, employees save time they would otherwise spend requesting reports, contacting colleagues, and waiting for answers from other departments. Implementing such a system, however, is difficult. As a result, known enterprise portals are inadequate in a number of respects. For example, typical enterprise portals on the market are built on a “data center” architecture that relies on centralizing the access to data in one server and which also requires a centralized, enterprise-wide planning and implementation program.

FIG. 1 presents a typical enterprise portal utilizing a data center architecture. As shown, the system comprises a number of departmental users 112-118 coupled over a network 122 to a centralized enterprise portal 102. Users 112-118 include Enterprise portal 102 gathers and processes data from a series of data sources 104-110 which are coupled to enterprise portal 102 via a network 120. This approach has at least three costly downsides. First, collecting and restructuring enterprise data to fit the schema of a centralized architecture consumes substantial enterprise resources. Second, any up-front planning and development time involves logistical and political roadblocks associated with building consensus for enterprise-wide issues. Third, as the number of users grows beyond the capacity of a single server, additional servers must be added. In the process, knowledge management and collaboration functions are often lost, isolating the users associated with the separate servers.

As mentioned above, the problem with the data center approach is that collecting and restructuring enterprise data to fit the schema of the data warehouse requires an exhaustive, labor-intensive effort that consumes substantial enterprise resources. As a result, the collection and distribution of data within the enterprise represents a serious bottleneck in the planning and execution of enterprise portals. In most cases, departmental portals need data from the organization's centralized systems combined with their own locally kept departmental data. However, departmental data is usually kept in departmental systems that are often not under the control of IT, and not maintained in the central data center. Many portal projects fail because of these planning and ownership issues. The data center approach is further hampered by the complexities of distributing data throughout user communities in diverse formats. As a result, enterprise portal projects built on data center architecture are rarely successful.

Building a portal based on data center architecture requires an investment of time and resources to plan and gain consensus on what data should be included in the data center. Budget and ownership issues magnify the difficulty in gaining consensus for the project. Even with strong leadership and commitment, it is often difficult to get all enterprise departments behind an enterprise-wide project, dedicating departmental budget and resources to the effort. These issues present a significant bottleneck to the overall project. As each department offers its vision of what the portal should provide, the scope of the project grows exponentially, requiring a costly and exhaustive planning process.

Methods are therefore needed in order to overcome these and other limitations of the prior art.

### BRIEF SUMMARY OF THE INVENTION

The present invention provides systems and methods which overcome the shortcomings of the prior art. In accordance with one aspect of the present invention, a distributed architecture for an enterprise portal involves a network of connected, department-sized portal servers working together as a group of federated portals. The word “federated” implies a union of independent entities working together to provide specific functions.

An enterprise portal architecture in accordance with one embodiment of the present invention includes a number of user systems connected, over a network, to at least two portals, a plurality of data sources coupled over a network to the portals, where each of the portals include a knowledge framework unit. The knowledge framework units, which are interconnected, each include a digital business identity and a knowledge broker, wherein the digital business identity includes a user directory configured to store information unique to a subset of said plurality of users, and wherein the knowledge broker includes a meta-data directory.

The alternative to data center enterprise portals disclosed is based on the idea that the benefits of the distributed computing model can be applied to portal development. A distributed architecture approach offers an attractive solution to the problems inherent in data center enterprise portals, i.e., planning, ownership, budgeting and technology issues such as scalability and growth.

### BRIEF DESCRIPTION OF THE SEVERAL VIEWS OF THE DRAWINGS

The subject invention will hereinafter be described in conjunction with the appended drawing figures, wherein like numerals denote like elements, and:

FIG. 1 is a schematic overview of a typical prior art portal implementing a data-center architecture;

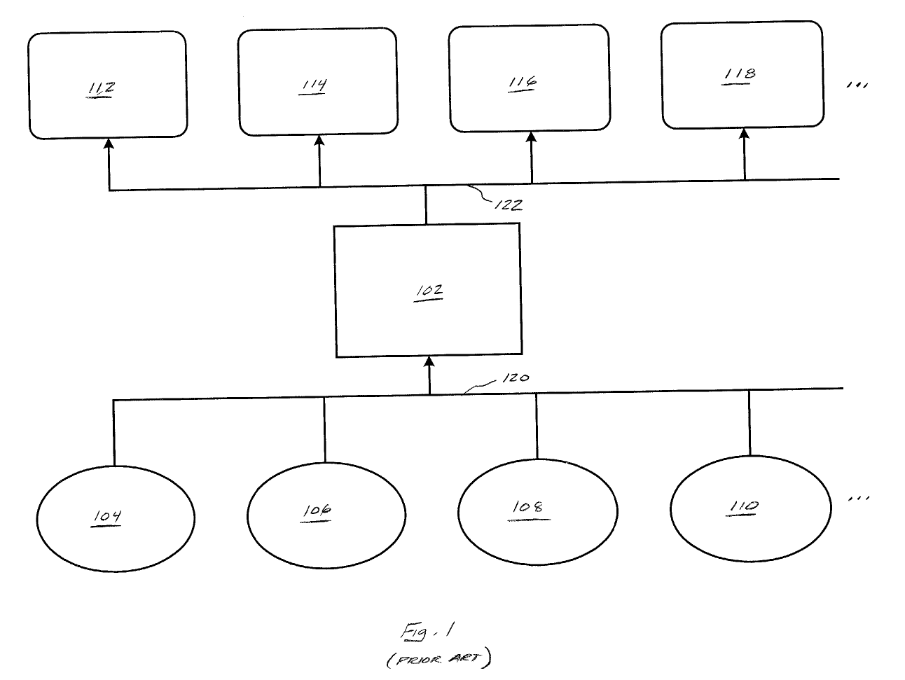

FIG. 2 is schematic overview of a federated portal architecture in accordance with one embodiment of the present invention; and

FIG. 3 is a schematic overview of another aspect of a federated portal architecture in accordance with the present invention.

### DETAILED DESCRIPTION OF PREFERRED EXEMPLARY EMBODIMENTS

Systems and methods in accordance with various aspects of the present invention provide for an enterprise portal including a network of connected, department-sized portal servers working together as a group of federated portals, i.e., a union of independent entities working together to provide specific functions.

In this regard, the present invention may be described herein in terms of functional block components and various processing steps. It should be appreciated that such functional blocks may be realized by any number of hardware and/or software components configured to perform the specified functions. For example, the present invention may employ various servers, databases, computers, integrated circuit components, digital signal processing elements, and the like. In addition, those skilled in the art will appreciate that the present invention may be practiced in any number of data communication and network contexts (i.e., the Internet, intranets, extranets, etc.) and that the various systems described herein are merely exemplary applications for various aspects of the invention. Such general techniques that are known to those skilled in the art are not described in detail herein.

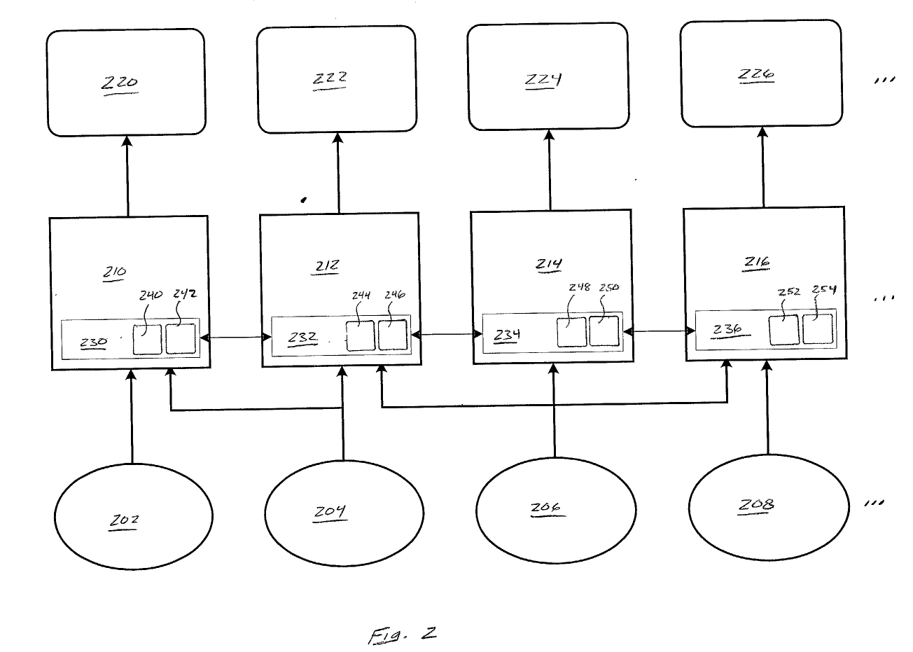

Referring now to FIG. 2, an enterprise portal in accordance with one embodiment of the present invention comprises a number of users (e.g., users 220-226) coupled to respective portals 210-216 (e.g., sales portals, executive portals, vendor portals, and the like) which are themselves connected to any number of data sources (e.g., data sources 202-208). Each of the portals 210-216 includes a corresponding knowledge framework unit 230-236, wherein the knowledge framework structure comprises a shared user directory structure referred to as a “digital business identity” (DBI) (240, 244, 248, and 252), and a cooperative metadata directory referred to as a “knowledge broker” (KB) (242, 246, 250, and 254).The federated portals (i.e., portals 210-216), or simply “federation”, share a common knowledge framework across all federated servers that use common object models and protocols for communication, e.g., XML and LDAP. As will be discussed further below, DBI maintains an identity record for each user, and KB maintains metadata information about the various data and information sources available to the user. Each server in the federation utilizes core components to determine which server can best meet user requests for information or assistance. As shown, the various knowledge framework units 230, 232, 234, and 236 are suitably coupled to provide communication therebetween. The federated portals themselves also share data from the various data sources 202-208. That is, data source 204 is coupled to portals 210 and 212, and data source 206 is coupled to portals 212, 214, and 216. It will be understood that the topology of data sources and portals as shown is merely an example, and that any number of data sources and portals may be employed.

Users 220-226 may access the various enterprise servers 210-216 using any combination of hardware and software components and any convenient means of data communication. For example, user 220 may utilize a conventional personal computers configured with a suitable operating system and web-browser, while user 222 may be utilize a personal data assistant (PDA) configured with a wireless-application protocol (WAP) browser. Those skilled in the art will appreciate that the present invention is not limited to the use of standard web browsers in conjunction with the HTTP protocol, and that a wide range of communication protocols, client software programs, wired and wireless data communication modes, and the like may be employed. For more information regarding data communication, the Internet, and related subjects see, e.g., Dilip C. Naik, Internet Standards and Protocols (Microsoft, 1998); Gilbert Held, Understanding Data Communications (1996).

The distributed architecture as shown in FIG. 2 allows local departments (associated with each of the individual portals) to maintain control of their data and handle budget considerations related to planning and implementing the portal at the departmental-level. A distributed architecture allows departmental line-of-business executives to build portal applications tailored to the unique needs of the department in a much shorter time than it would take to build traditional data-center enterprise portals. The present invention thus provides scalability, built-in redundancy, and the ability to invest incrementally so that the enterprise portal can be designed and built without the massive, enterprise-wide planning effort required by data center enterprise portals previously described.

Another advantage of the distributed architecture model is its ability to include portals from an organization's partners and suppliers as part of the federation. That is, an individual portal, such as portal 216, may be associated with a partner of the organization utilizing the federated portal architecture. As a result, the federated portals support information sharing, collaboration, and decision making throughout an organization's value chain, not just between and within its internal departments. This is in contrast to the emphasis of traditional supply-chain and value-chain automation, which is primarily focused on the transaction side of business, for example, sending and receiving purchase orders, monetary transactions, inventory adjustments, etc. A distributed architecture allows an enterprise to bring the information sharing and decision-making benefits of a portal to the entire value chain.

In a federated portal architecture, some data must be shared between the servers in the federation. Other data is specific to the application and is stored locally. As mentioned briefly above, the shared data comes in two types: user-specific information, e.g. everything stored in the DBI for a user, and data needed across applications, e.g. the KB data.

Digital Business Identity (DBI)

Digital Business Identity (DBI) 240, 244, 248, and 252 includes one or more software objects configured to assign each user (220-226) an identity that describes his/her role, activities, skills, and position in the organizational chart. In this regard, each DBI may include information about a user's skills, role within the organization, projects/activities being worked on, interests, preferences, etc. Personalization information stored in connection with a DBI helps users come together by identifying one another to collaborate, make better decisions, solve problems, and contribute to the overall knowledge of the organization.

Knowledge broker (KB)

The Knowledge Broker (KB) provides users with access to the information they need by creating and maintaining data relationships. Knowledge Broker implements and facilitates relationships between information and information, people and information, and people and people. 242, 246, 250, and 254. This repository houses the metadata that contextually ties together data sources with other data sources, people with data sources via reports and queries, and people with data-related events (e.g. alerts).

The Knowledge Broker metadata preferably grows as departments add more portals and connect them to various data sources, and as the number of users increase. Given that a Knowledge Broker repository is more powerful as the number of portals increase, the servers within the federation preferably exchange information stored in their respective knowledge repositories. The federated architecture allows metadata to be distributed across a group of portals, allowing users of any one portal to seamlessly leverage the knowledge repositories of other portals in the federation.

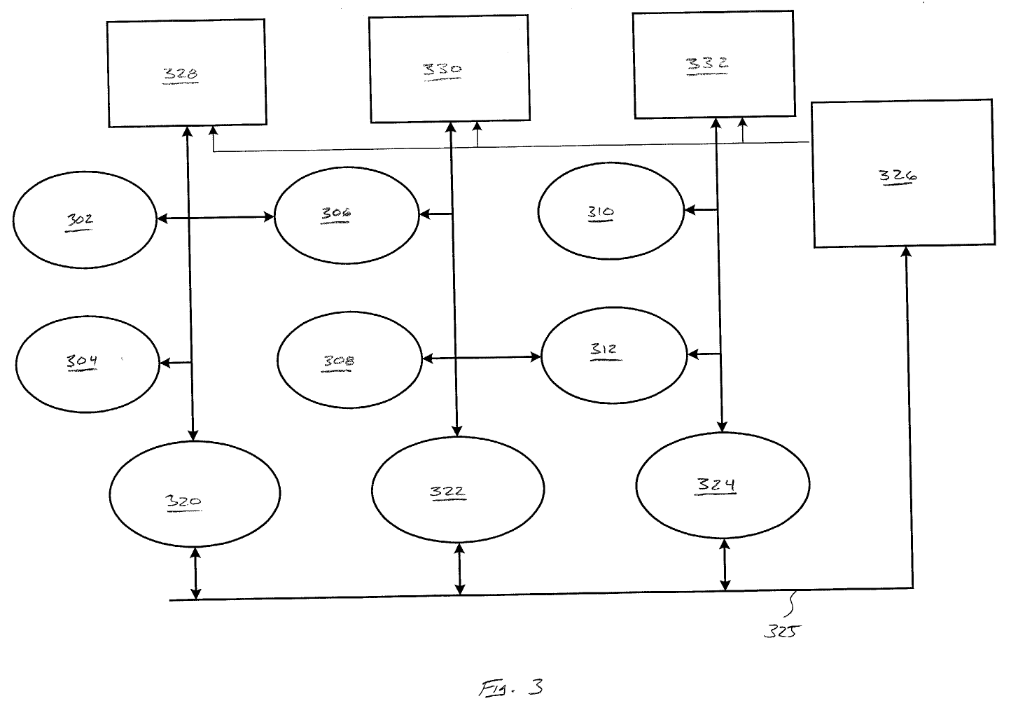

It may also be advantageous to configure multiple enterprise portals into a single “domain.” FIG. 3 shows one embodiment of the present invention useful in illustrating the nature of such domains. At the top of the figure, a number of portal servers 328, 330, and 332 are shown. Each is coupled to one or more data sources (302-312). Furthermore, each portal 328, 330, 332 has a corresponding repository 320, 322, and 324 respectively. A knowledge directory server 326 is provided for communicating over a knowledge bus 325 with repositories 320, 322, and 324, and for communicating with the various portals 328, 330, and 332.

Server 328 may comprise, for example, local data sources (e.g., ERP, data warehouse, legacy systems, intranet sources for files and documents, etc) and is connected to or contains its own knowledge repository 320 where DBI and KB information is stored for users of server 328. Similarly, servers 330 and 332 include their own local data sources. Together, these three portals make up a domain. In order for the domain members to share knowledge repositories 320, 322, and 324, (which in turn include the pertinent DBI and KB objects), the federated server bus 325 uses a pluggable architecture to bind the three portals together, allowing them to share information. This is preferably achieved by the federated knowledge directory 326, which manages the repositories 320-324.

The federated knowledge directory 326 is the domain controller and contains information related to the knowledge held by each of the portals 328-332. This information is exported to the knowledge server by each knowledge portal via, for example, XML information transmitted on the federated server bus 325. The knowledge directory server 325 allows users of an individual portal to make use of information in other repositories. This is accomplished without having to centralize all the information in one location and without the user knowing that information is coming from a different portal. Thus, the transfer of data between data sources is essentially invisible to the user. It will be appreciated that this design allows the incremental addition of portals to a domain and, consequently, the federation.

In one embodiment, A domain in a federation comprises portal sub-groups related by either a) geographical proximity or, b) a logical grouping based on user requirements for peripheral vision (i.e., the ability to see information from different but related areas). Each portal in the domain represents a distinct user community. For example, a typical domain in a federation might consist of an executive portal connected to financial and operational systems, a field sales portal connected to CRM, customer service and order status systems, a partner portal connected to an e-commerce system, and a portal for customer service and order status systems. Each user community not only has access to relevant data on the home server, but also has access to information on the other servers in the domain. Restrictions to this access are governed only by security rules. This means that users who are stakeholders in a particular decision can share facts, collaborate to reach consensus, and jointly participate in the execution of the decision.

In addition to simply accessing data from different data sources through the federated portals, certain functionality is preferably added to the interface to allow the user to process and display the data in a desirable fashion. For example, in one embodiment, the system provides “Business Analysis” functions which allow users to turn reports into charts and spreadsheets from within the same portal interface. Once converted, the charts and spreadsheets can display the results of “what-if” type calculations. They can also be saved to a local or network file for use in commercial desktop analysis tools. The system may also include an “Intranet Search” function; i.e., the ability to search for data within multiple enterprise information sources. Collaboration components may also be provided to allow users to share information and communicate regarding information in real-time or through the use of message boards and the like.

Communication and synchronization protocols are preferably managed a system level. The software that allows federated portals to work together, and not the software that determines the information content of the portal, handles these basic, portal-infrastructure duties

Business decisions are made most effectively at the department and even group-level. However, the velocity with which business needs change, especially at the departmental level, threatens the relevance of a long-term enterprise-wide portal effort. Enterprise portal projects often stall or are scaled back dramatically because of disconnects within the enterprise regarding planning, ownership, and budgeting issues. The federated portal architecture addresses this problem by distributing power, that is, by building multiple, locally owned portals—not one centralized portal—and thus increases the speed at which design decisions can be made and at which portals can be developed.

The present invention allows each department to shape and guide their own portal. The federated portals allow for local, user level input into the design and implementation of a portal solution. In addition to the advantages of local, departmental planning and budgetary control, the present invention offers sound technological advantages over a centralized, data center architecture. A distributed architecture establishes a solid foundation that allows for incremental investment, rollout, scalability, and growth. That is, the present invention allows bandwidth, hardware, administration, and other infrastructure costs to be distributed over time, keeping pace with the development and deployment of the departmental portal servers.

In accordance with one aspect of the present invention, bandwidth needs are efficiently accounted for in the federated portal environment. Instead of routing all user traffic to a central portal server (or a central cluster of servers), the federated architecture keeps most of the traffic local to the individual portal server. In addition, portal servers can be set up in close proximity to the departmental systems to which they connect, which reduces networking and system-interfacing costs.

The distributed nature of the federation, and the fact that servers in the federation communicate with each other, allows a degree of flexibility in the implementation of connections between portal servers and data sources. A distributed architecture does not require that every data source be connected directly to every portal server. This allows the option of configuring the federation so that it best suits the infrastructure of data sources that it must communicate with.

In accordance with another aspect of the present invention, a distributed architecture as shown tends to support a large variety of connected systems. A portal server in the Finance department might, for example, be connected to an Exchange mail system, while the HR department portal could rely on an existing Notes Mail infrastructure. In this case, each server is individually configurable for its outward-facing connections while still connected to the federation using neutral protocols. The federated portal approach guarantees the scalability of the portal system at the enterprise level. This approach spreads user communities across a number of servers working together. Departmental portals supply the user's primary needs, while additional servers supply specific, enterprise-based information.

To add new capabilities to the system as shown, rather than replace or rebuild a portal server, it is possible to leave the existing servers in place and route requests that require new features (an improved search engine for instance) to a new server. Existing portal applications are thereby only minimally impacted.

There are at least three reasons to add enterprise servers to a federation; i.e., to scale existing applications to a large numbers of users, to add functionality to existing applications by deploying a new server that provides that function, such as a customized form for searching and indexing, and to bring additional user communities on-line with new applications while building on the KB and DBI data that already exists.

Because a distributed architecture in accordance with the present invention provides a shared structure, it is possible to build portals simultaneously for several departments without requiring the large up-front planning needed for a monolithic enterprise portal.

The usefulness and power of any portal application is proportional to the number of systems it connects to. Portal applications built using an architecture in accordance with the present invention can access data from more systems and can, therefore, be used for processes that span a number of data sources or enterprise IT systems. Under a federated portal architecture, it is not necessary to connect every portal server to every data source. This is because a single portal server can store query results (and other analysis) that run against systems it connects to, then share these results with other servers in the federation. In this case, servers within the federation can share to the degree allowed by security.

In accordance with another aspect of the present invention, the user's view of the system can change from an application-centric one (i.e., one that is dictated by the arrangement of systems they use), to a view determined by the role of the individual user. Because the portal provides one user interface to many systems, the distinction between those systems can be bidden from the user, and replaced with a portal console that conforms more to the user's job than it does to the artifacts of the IT infrastructure.

In the context of the World Wide Web, users navigate from site to site to work with different vendors or partners. Each of these sites is different, with a different interface, different mechanism for searching, creating/executing transactions, and so on. In accordance with the present invention, the basic information and collaboration data is shared between portals even if each portal presents the information differently or implements a different user interface. Thus, a user can participate in a workflow from another department (or even a partner) using the workflow tools, which they are familiar with from their own portal.

In summary, a distributed architecture enterprise portal as described above gives business executives and managers the responsibility and power to plan and build smaller departmental portals that satisfy their unique needs and requirements sooner rather than later. These departmental portals can still participate in a larger, networked, implementation of a true enterprise portal. The end result is incremental investment, faster deployment, and a greater return on investment. This model reduces the time and consensus building required in the planning stages. With departmental control and leadership from the organizational IT group, planning and budgeting issues are more manageable, the purpose and expectations of the portal are more clearly defined, and the portal strategy is seen by department level executives as having clear, tangible benefits for their short and long term needs.

Although the invention has been described herein in conjunction with the appended drawings, those skilled in the art will appreciate that the scope of the invention is not so limited: Modifications in the selection, design, and arrangement of the various components and steps discussed herein may be made without departing from the scope of the invention as set forth in the appended claims.

What is claimed is:

1. An enterprise portal architecture comprising:
a plurality of user systems connected, over a network, to at least two portals;
a plurality of data sources coupled over a network to said portals;
said portals including a knowledge framework unit, said knowledge framework unit including a digital business identity and a knowledge broker, wherein said digital business identity includes a user directory configured to store information unique to a subset of said plurality of users, and wherein said knowledge broker includes a meta-data directory.

2. The enterprise portal architecture of claim 1, wherein one of said portals includes a sales portal.

3. The enterprise portal architecture of claim 1, wherein one of said portals includes an executive portal.

4. The enterprise portal architecture of claim 1, wherein one of said portals includes a partner portal.

5. The enterprise portal architecture of claim 1, wherein one of said portals includes a vendor portal.

6. The enterprise portal architecture of claim 1, further including a federated knowledge directory server coupled to said portals and said knowledge framework units.
